(19) United States
(12) Patent Application Publication
(10) Pub. No.: US 2003/0084764 A1
(43) Pub. Date: May 8, 2003

(54) Method and apparatus for replacement of ductile pipe

(76) Inventor: Steven W. Wentworth, Brookfield, WI (US)

Correspondence Address: Philip G. Meyers, Philip G. Meyers Intellectual Property Law, P.C., Suite 302, 1009 Long Prairie Road, Flower Mound, TX, 75022, US

(21) Appl. No.: 10/040,592

(22) Filed: Nov. 7, 2001

(51) Int. Cl. B26D 1/00; B26D 3/00; B31B 1/25

(52) U.S. Cl. 83/13; 83/879

(57) ABSTRACT

An apparatus for pipe slitting according to the invention includes a front rod configured for connection to a string of rods, a frame connected to a rear end of the rod having a lengthwise slot therein, an axle mounted in the slot, a rolling cutter mounted on the axle such that a portion of the cutter protrudes from the slot in a position suitable for slitting a ductile pipe through which the slitter is drawn, and a frustoconical expander connected to the rear of the frame and sized to expand a slit pipe. The frame may have has a series of lengthwise slots therein with an axle mounted in each slot, and a rolling cutter mounted on each axle such that a portion of each cutter protrudes from the slot in a position suitable for slitting a ductile pipe through which the slitter is drawn. In such an embodiment, preferably each rolling cutter behind the front cutter extends further outward than the cutter preceding it, and the frame has a sliding reaction surface (free of wheels) that engages an inner wall of the pipeline on the side opposite the rolling cutters.

### TECHNICAL FIELD

The invention relates to a method and apparatus and system for splitting and replacing existing pipelines and in particular, pipelines made from a ductile material such as ductile iron.

### BACKGROUND OF THE INVENTION

Conventional cast iron pipe tends to be brittle and will break and fragment upon only a moderate impact. Cast iron pipe is therefore relatively easy to burst and the fragments may be pushed aside as the bore is expanded. Steel pipe tends to be ductile, and slits without fragmenting. Because of its ductility, a bore in which steel pipe has been installed may be slit and expanded without fragmenting the pipe. Steel pipe sections are typically coupled by welding, and thus the connections do not normally present any special difficulties when the pipe is slit.

Ductile iron pipe on the other hand, is considerably more difficult to slit than either cast iron or steel pipe. Ductile iron pipe is a ferrous pipe that is typically supplied in sections seventeen to twenty feet long, although shorter and longer sections may be used. Compared to cast iron pipe, DIP is able to flex and bend a significant amount before cracking. Ductile iron pipe (DIP) has therefore been found suitable for applications requiring a higher degree of flexibility and impact resistance than provided by cast iron pipe. In this respect, DIP more resembles steel pipe than cast iron pipe. However, unlike cast iron pipe, slitting ductile iron pipe requires a stout blade to cut through the pipe wall and significant expansion of the resulting cut to bend and ultimately produce an axial crack in the pipe wall opposite the cut. When such a crack is formed, it tends to be a jagged-edged “alligator” type crack with fragments or splinters that remain attached to the pipe at either end. In some cases these splinters will separate from one or the other side of the cracked pipe, however, in most cases the fragments do not separate.

Ductile iron pipe is typically provided in sections with a cast bell on one end and a spigot on the other. Connections between pipe sections are formed by installing an o-ring over the spigot or into the bell and fitting the spigot end of one piece into the bell end of the adjacent piece. One of the most difficult aspects of slitting ductile iron pipe is the wide-spread use of Dresser-type repair couplers. These couplers are large diameter devices formed with a thick cross section and are made from extremely tough, ductile material, further exacerbating the difficulty of slitting and expanding ductile iron pipelines for installation of new pipe.

A number of devices for slitting and expanding bores have been proposed. For example, U.S. Pat. No. 5,098,225 discloses a cutting/expanding tool including a cylindrical support body having a guide side and a cutting side, a pair of guide rollers mounted in tandem along the longitudinal axis of the support body on the guide side and a cutting wheel mounted between the tandem guide rollers on the cutting side of the support body. The tool also includes an expander connected rearwardly of the support body. The patent also discloses a plurality of cutting wheels of progressively increasing diameter. A scoring wheel may be mounted forwardly of the cutting wheels to prescore the surface to be cut, so as to facilitate the cutting action, and a deburrer may be mounted rearwardly of all the cutting wheels so as to smooth the cut edge. The tool is propelled through a buried main to cut and to expand it and a replacement main is drawn back through the existing main.

U.S. Pat. No. 5,078,546 discloses a tool for slitting and laterally expanding underground steel gas mains and inserting replacement plastic piping into the spread apart pipeline. The tool has a forward end cylindrical portion mounting a single, rearwardly angled blade to make only one line of cut, and an eccentrically disposed conical pipe spreader portion at its rearward end. A single roller type pipe slitter aligned with the fixed blade may be mounted on a removable extension of the forward end cylindrical portion, to initially groove and weaken the pipe along the intended line of cut. A pneumatically operated impact ram is attached to the rearward end of the tool, as is the leading end of the replacement piping. The tool is configured to be pulled through an underground pipe with a wire cable, grooving, slitting and laterally expanding the pipe.

These systems have met with success in practice but are elaborate in structure and thus expensive to produce and more prone to breakage than a system with fewer parts.

### SUMMARY OF THE INVENTION

An apparatus for pipe slitting according to the invention includes a front rod configured for connection to a string or rods, a frame connected to a rear end of the rod having a lengthwise slot therein, an axle mounted in the slot, a rolling cutter mounted on the axle such that a portion of the cutter protrudes from the slot in a position suitable for slitting a ductile pipe through which the slitter is drawn, and a frustoconical expander connected to the rear of the frame and sized to expand a slit pipe. The frame may have has a series of lengthwise slots therein with an axle mounted in each slot, and a rolling cutter mounted on each axle such that a portion of each cutter protrudes from the slot in a position suitable for slitting a ductile pipe through which the slitter is drawn. In such an embodiment, preferably each rolling cutter behind the front cutter extends further outward than the cutter preceding it, and the frame has a sliding reaction surface (free of wheels) that engages an inner wall of the pipeline on the side opposite the rolling cutters.

According to another aspect of the invention, the slitter may have one or more pivoting connections that better enable the device to conform to bending forces encountered as it is drawn through the ground. A pivoting connection may be provided between the front rod and the frame. Most preferably, a rigid link interconnects the frame and the expander. The link is connected by front and rear pivoting connections. There and other aspects of the invention are discussed in the detailed description that follows.

### BRIEF DESCRIPTION OF THE DRAWING

In the accompanying drawing, where like numerals denote like elements:

FIG. 1 is a perspective view of a ductile pipe slitter according to the invention;

FIG. 2 is a top view of the slitter shown in FIG. 1;

FIG. 3 is a side view of the slitter shown in FIG. 1;

FIG. 4 is a bottom view of the slitter shown in FIG. 1;

FIG. 5 is a sectional view taken along the line 4-4 in FIG. 1; and

FIG. 6 is a perspective view of a pivot according to the invention.

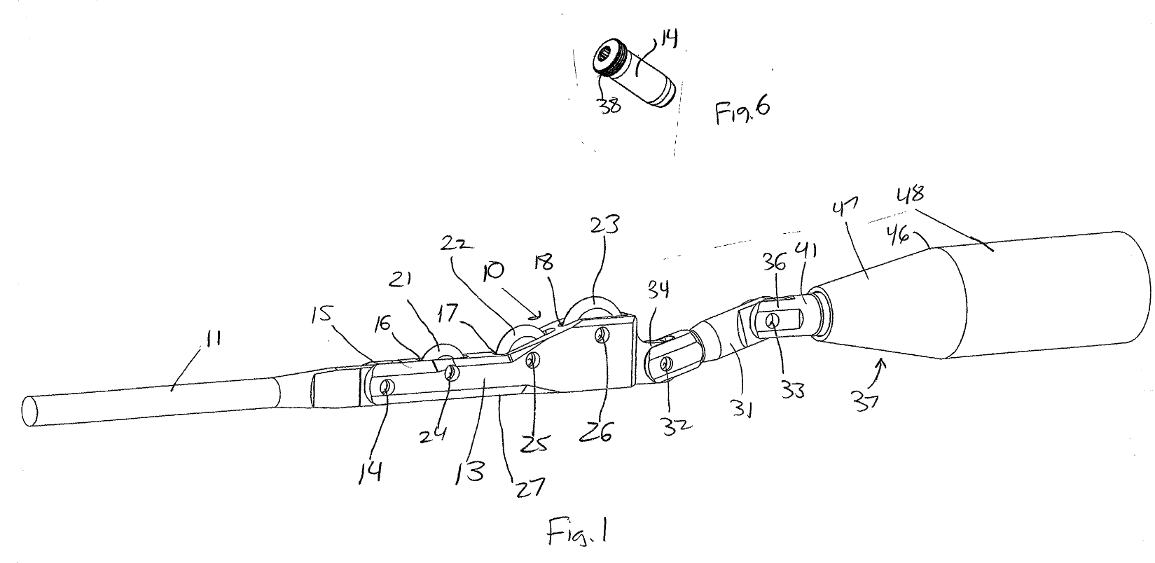

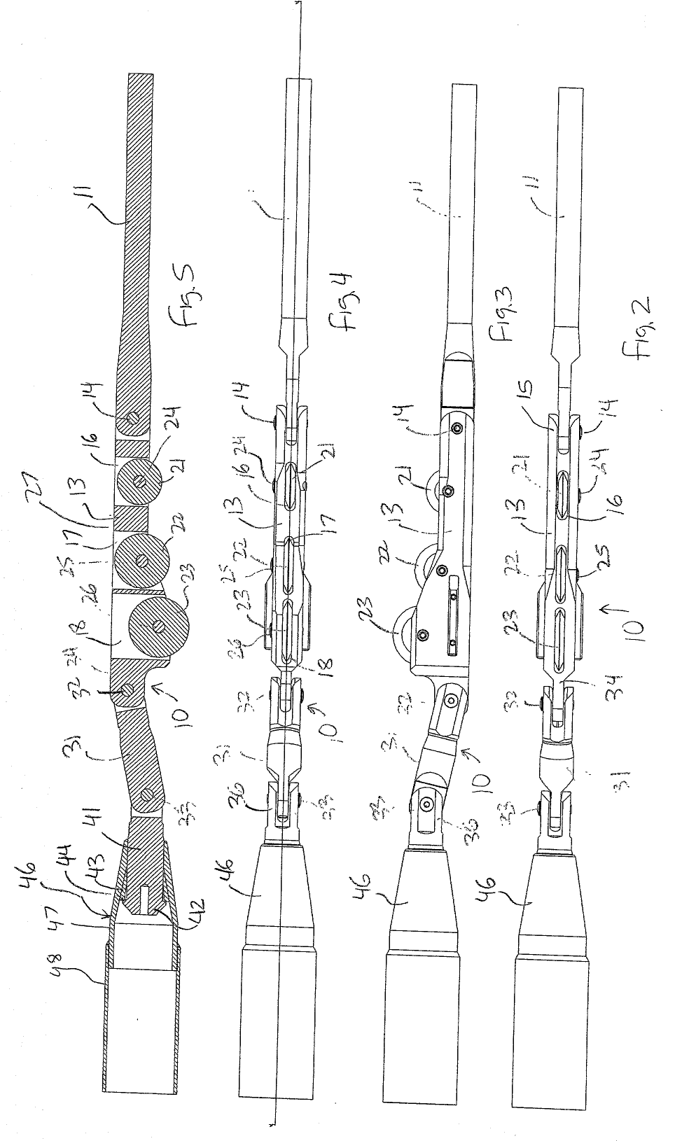

### DETAILED DESCRIPTION OF THE INVENTION

While the making and using of various embodiments of the present invention are discussed in detail below, it should be appreciated that the present invention provides many applicable inventive concepts which can be embodied in a wide variety of contexts. The embodiments discussed herein are merely illustrative of specific ways to make and use the invention and do not limit the scope of the invention.

A pipe slitter 10 of the invention lacks fixed blades and does not require wheels to aid in sliding along the inside of the pipe to be split. A rod 11 at the front end of slitter 10 has a smaller diameter than the pipe to be slit and suitable means, such as a threaded end, for connection to a string of rods used to pull the slitter through the existing ductile iron or similar pipeline. A frame 13 is mounted behind rod 12 and connected thereto, such as as by a front pivot 14 set in a clevis 15 at the front of frame 13. Frame 13 has a series of outwardly opening slots 16, 17, 18 in which a series of rolling, cutting blades or cutters 21, 22, and 23 are mounted on axles 24, 25 and 26 respectively. Each cutter 21-23 extends further outward radially than the cutter(s) in front of it, such that slitter 10 can be used to slit pipes of a variety of sizes. In the illustrated embodiment, this is accomplished by making cutters 21-23 of progressively increasing diameter and moving the axis of rotation for each cutter 21-23 outwardly relative to the preceding cutter.

As one or more of cutters 21-23 engage and slit an iron pipe, an opposite surface 27 of frame 13 slides along the inside of the pipe on the side opposite the cut. Since slitter 10 lacks wheels on surface 27, it will require more force to draw through, but the rolling blades will compensate for this in part as compared to fixed slitting blades. The lack of rolling wheels also makes the front end of the device smaller, permitting it to fit more readily into smaller pipelines.

A rigid link 31 is connected by a pair of pivots 32, 33 to a rear end tab 34 of frame 13 having a hole therethrough in which pivot 32 is mounted and a front end clevis 36 of an expander assembly 37. Pivots and axles 14, 24-36, 32 and 33 of the invention may each comprise bolts having threads 38 at one end secured in corresponding threads in the adjoining member. Expander assembly 37 includes a central pulling shaft 41 having front clevis 36 formed thereon and an enlarged diameter rear portion 42. A frontwardly tapering frustoconical sleeve 43 is mounted on the outside of shaft 41 ahead of enlarged diameter portion 42, which has a step 44 that retains sleeve 43 against rearward movement. Sleeve 43 is wedged against the inside of an expander 46, which has a front, forwardly tapering frustoconical front section 47 threadedly coupled to a rear cylindrical section 48 which can vary in length. A replacement pipe is secured to the rear of shaft 41 and drawn along behind the device, preferably with the front end thereof disposed inside cylindrical section 48, using a conventional pipe pulling connector.

During use, the slitter 10 is mounted at the terminal end of a string of rods at the entry pit or manhole and pulled into the ductile metal pipeline until one or more of cutters 21-23 engage the inside of the pipeline. The pipe pulling machine, such as a Hydroburst unit made by Earth Tool Company, is operated to draw slitter 10 progressively through the pipeline creating a lengthwise slit therein. Expander 46 then engages the slit pipeline and spreads it out, making room for the replacement pipeline that is drawn in behind it. The old pipe is left in the ground outside of the new one. The pivotal connections 14, 32 and 33 permit the slitter to bend at three locations to better accommodate bending forces exerted on the slitter during operation. Upon reaching an exit pit or manhole, slitter 10 exits the slit pipeline and can be removed from the rod string.

While certain embodiments of the invention have been illustrated for the purposes of this disclosure, numerous changes in the invention presented herein may be made by those skilled in the art, such changes being embodied within the scope and spirit of the present invention as defined in the appended claims.

1. A pipe slitter comprising:
a front rod configured for connection to a string of rods;
a frame connected to a rear end of the rod having a lengthwise slot therein, an axle mounted in the slot, and a rolling cutter mounted on the axle such that a portion of the cutter protrudes from the slot in a position suitable for slitting a ductile pipe through which the slitter is drawn; and
a frustoconical expander connected to the rear of the frame and sized to expand a slit pipe.

2. The slitter of claim 1, wherein the frame has a series of lengthwise slots therein, an axle mounted in each slot, and a rolling cutter mounted on each axle such that a portion of each cutter protrudes from the slot in a position suitable for slitting a ductile pipe through which the slitter is drawn, wherein each rolling cutter behind a front cutter extends further outward than the cutter preceding it.

3. The slitter of claim 1, further comprising a pivoting connection between the rod and the frame.

4. The slitter of claim 1, further comprising
a rigid link; and
front and rear pivoting connections which connect the link to a front end of the expander and a rear end of the frame.

5. The slitter of claim 1, wherein the frame has a substantially flat reaction surface which slidingly engages an inner wall of the pipeline on a side opposite the rolling cutters.

6. A pipe slitter comprising:
an elongated front rod configured for connection to a string of rods;
a frame connected to a rear end of the rod having a series of lengthwise slots therein, an axle mounted in each slot, and a rolling cutter mounted on each axle such that a portion of each cutter protrudes from the slot in a position suitable for slitting a ductile pipe through which the slitter is drawn, wherein each rolling cutter behind a front cutter extends further outward than the cutter preceding it, the frame having a substantially flat outer reaction surface which slidingly engages an inner wall of the pipeline on a side opposite the rolling cutters;
a pivoting connection between the rod and the frame comprising a pivot pin inserted through engaged end portions thereof;
a frustoconical expander connected to the rear of the frame by a rigid link and sized to expand a slit pipe;
front and rear pivoting connections which connect the link to a front end of the expander and a rear end of the frame.

7. The pipe slitter of claim 6, wherein each pivoting connection comprises a tab having a first hole therethrough inserted into a clevis having a pair second and third holes therethrough aligned with the first hole in the tab, and a pin inserted through the first, second and third holes, which pin is threadedly secured in one of the first and third holes by external threads formed at one end of the pin.

8. The pipe slitter of claim 7, wherein the axles on which the rolling cutters are mounted each comprise a pin inserted through aligned holes in the frame and cutter, which pin is threadedly secured in one of the holes in the cutter by external threads formed at one end of the pin, such that the pins used as the axles are identical to the pins used in the pivoting connections.
